(19) United States
(12) Patent Application Publication
(10) Pub. No.: US 2015/0289530 A1
(43) Pub. Date: Oct. 15, 2015

(54) METHOD FOR THE HIGH-PRESSURE TREATMENT OF BREAST MILK

(71) Applicant: HPBIOTECH, Gradignan (FR)

(72) Inventors: Gerard Demazeau, Gradignan (FR); Nolwennig Rivalain, Talence (FR); Claude Billeaud, Bordeaux (FR)

(21) Appl. No.: 14/438,787

(22) PCT Filed: Oct. 23, 2013
(86) PCT No.: PCT/FR2013/052532

§ 371 Date: Apr. 27, 2015

(30) Foreign Application Priority Data
Oct. 26, 2012 (FR) 12 60215

(51) Int. Cl. A23C 3/00; A23L 3/015; A23C 9/20

(52) U.S. Cl. CPC A23C 3/00; A23C 9/206; A23L 3/0155; A23V 2002/00

(57) ABSTRACT

A method for the treatment of breast milk, which includes at least two cycles, each cycle includes subjecting the medium to a maximum pressure of between 200 and 400 MPa with a compression speed of between 0.5 and 8 MPa·s⁻¹ and a decompression speed of between 0.5 and 100 MPa·s⁻¹, the initial temperature of the medium being between 25° C. et 50° C. Also, the use of the method, the resulting product and the use thereof in order to meet the nutritional and metabolic requirements of premature babies and nursing infants.

This invention relates to a process for pressurized treatment of breast milk, in particular for deactivating the pathogenic agents that are present and for improving its preservation.

It is known that breast milk constitutes a biological medium that is completely suitable for nursing infants, particularly for premature babies, in particular because of its nutritional, enzymatic and antibacterial properties.

In a natural manner, the breast milk is delivered from the mother to the baby, but sometimes, particularly in the event of infection in the mother or because of a mother's lack of milk, it is necessary to be able to provide breast milk that is safe from the microbiological standpoint to ensure the proper development of the baby. This milk is collected from nursing mothers and treated by specialized centers called lactariums.

Currently, breast milk is treated by low-temperature thermal pasteurization or equivalent processes. This process consists in treating the breast milk at a temperature of 63° C. for approximately 30 minutes.

Although this process is virtually the only treatment used today, it nevertheless has significant drawbacks. In particular, it imposes two types of limits:
A first limit in terms of overall effectiveness at the level of microbiological safety relative to vegetative forms and ineffectiveness relative to sporulated forms,
A second limit in terms of safeguarding characteristic properties of breast milk, particularly nutritional, enzymatic and antibacterial properties.

The first limit means, on the one hand, that it is not possible to make lots of heavily contaminated breast milk safe (in France, this is the boundary threshold of 10⁶ UFC/ml for the total flora that has been adopted by the health authority as an acceptable limit; beyond this limit, the milk is regarded as not being able to be treated by the pasteurization process at low temperature), and, on the other hand, that it is ineffective with respect to the contamination by bacterial spores. These two constraints result in the rejection of lots of breast milk (approximately 10 to 15%) relative to those collected. This problem is all the more serious since there exists a significant lack of donations of breast milk relative to the needs.

The second limit relates to the properties of the product and its suitability with its objectives in terms of effectiveness. Actually, the heat treatment leads to a degradation of the activity of a certain number of characteristic components of the breast milk that are, however, essential for the newborn, in particular for the premature baby. This is the case of, for example, lipase, which plays an important role in the digestion of the lipids of milk, which is degraded and loses all of its activity after pasteurization treatment.

Finally, the treated milk also poses storage problems and requires freeze-drying to be able to be transported over long distances, which can also act on its quality and its properties.

There is therefore a need for a new treatment of the breast milk that makes it possible to obtain a product that is completely safe from the microbiological standpoint, while preserving its nutritional, enzymatic, and antibacterial properties. This is the objective of this invention, which for this purpose proposes a process for treatment of the breast milk by application of high pressure.

Several processes for treatment of food products and breast milk in particular have been described recently. This is the case particularly of the works described in a publication (M. PERMANYER et al. “Maintenance of Breast Milk Immunoglobulin A After High-Pressure Processing,” J. Dairy Science (2012), 93, pp. 877-883) that demonstrate that the use of pressure makes it possible to deactivate certain microorganisms while preserving the activity of immunoglobulin A. However, these processes use pressures of at least 400 MPa, therefore able to bring about a broad loss of activity of certain essential components of breast milk, such as lipase. In addition, the process that is described makes it possible to treat the bacterial agents in the vegetative state and not the spores, in particular Bacillus cereus, which are, however, often observed as contaminating breast milk.

This invention makes it possible to remedy the drawbacks of the processes of the prior art by proposing a process for treatment of breast milk, comprising at least two cycles, with each cycle consisting in applying to the medium a pressure of between 200 and 400 MPa with a compression speed of between 0.5 and 8 MPa·s⁻¹ and a decompression speed of between 0.5 and 100 MPa·s⁻¹, with the initial temperature of the medium being between 25° C. and 50° C.

In a surprising way, thanks to the specific combination of parameters used that act by synergy, this simple process makes it possible to deactivate the pathogenic agents that are present in the breast milk, including the bacterial spores, even though the pressure and the temperature that are used are not very high, while preserving a large majority of the activity of its essential components for premature babies and nursing infants.

The invention therefore also relates to the use of the process for deactivating at least one pathogenic agent that is present in breast milk, including bacterial spores, and for improving the preservation of breast milk.

Likewise, the object of the invention is the product obtained after treatment, made safe from the microbiological standpoint and having characteristics that are very close to those of the untreated, original breast milk.

The invention will now be described in detail.

The object of the invention is therefore a breast milk treatment process, comprising at least two cycles, each cycle consisting in applying to the breast milk a maximum pressure of between 200 and 400 MPa with a compression speed of between 0.5 and 8 MPa·s⁻¹ and a decompression speed of between 0.5 and 100 MPa·s⁻¹, with the initial temperature of the medium being between 25° C. and 50° C.

The treated breast milk is milk recovered after collection from a donor mother. This milk cannot be used as such because it may have microbiological contamination.

The process according to the invention consists in applying pressure to the breast milk in a cyclical fashion under certain conditions.

For implementing the process, the temperature of the medium is between 25 and 50° C., preferably between 30 and 40° C.

The process comprises at least two cycles for application of pressure, preferably at least three, even more preferably between two and six. Each cycle consists in passing the treated medium from the initial pressure to a maximum pressure of between 200 and 400 MPa, preferably between 270 and 330 MPa. This pressure can be constant or can vary during the same cycle. Likewise, for two different cycles, this pressure can be identical or different.

According to a particularly suitable embodiment, each cycle has an application period of the maximum pressure of the cycle of between 2 and 60 minutes, preferably between 2 and 10 minutes. The application period of the maximum pressure for each cycle can be identical or different.

The initial pressure, before the first cycle or between each cycle, can be the ambient pressure or an intermediate pressure of a value that is between the ambient pressure and the maximum pressure(s) of treatment applied during the preceding cycle and the following cycle.

There may be a latency period between each cycle. This latency period is preferably between 10 seconds and 5 minutes. The latency period between the cycles, if there are at least 3 cycles, may be identical or different.

In a preferred way, the latency period is carried out at the ambient pressure.

According to a variant, the latency period between two cycles can be carried out at an intermediate pressure of a value of between the ambient pressure and the maximum pressure(s) applied during the preceding cycle and the following cycle.

The compression speed, i.e., the speed of pressure increase, is between 0.5 and 8 MPa·s⁻¹, preferably between 0.5 and 2 MPa·s⁻¹. This speed may be constant or variable until the desired pressure is reached. Likewise, for two different cycles, the compression speed can be identical or different.

The decompression speed, i.e., the speed of pressure decrease, is between 0.5 and 100 MPa·s⁻¹, preferably between 0.5 and 8 MPa·s⁻¹, and even more preferably between 0.5 and 2 MPa·s⁻¹. This speed may be constant or variable until reaching the desired pressure. Likewise, for two different cycles, the decompression speed may be identical or different.

For the same cycle, the compression and decompression speeds can be identical or different.

Each cycle has a compression profile and a decompression profile.

The compression or decompression profile corresponds to the general form of the application of the pressure during the increase or decrease. Thus, the compression and the decompression can be done in a monotonic manner (at constant speed or with variable speeds) or with one or more pressure stages. Each stage is carried out by applying a constant intermediate pressure of a value that is located between the lowest pressure of the cycle and the highest pressure of the cycle. Reaching this stage or these stages can be done at a constant speed or at variable speeds. Before and after each stage, the application speed can be identical or different.

For the same cycle, the compression profile and the decompression profile can be identical or different.

For two different cycles, the compression profiles can be identical or different. Likewise, for two different cycles, the decompression profiles can be identical or different.

The process can be implemented using “high-pressure” devices suited to the conditions of the invention.

The medium that is to be treated is to be conditioned in a completely or partially deformable packaging that is necessary for transmitting pressure. For example, it may involve a packaging made of rigid material such as glass or plastic, closed by a deformable lid or having a deformable part. It may particularly involve a container of the rigid baby bottle type with a deformable lid. The volume of the container can be adjusted to the needs of the premature baby or the nursing infant. Thus, smaller volumes, on the order of 20 to 50 cm³, will be more appropriate for very young premature babies whereas larger volumes, on the order of 100 to 200 cm³, will be more suited to the needs of older babies.

Advantageously, the combination of the different characteristics of the process leads to:
The deactivation of pathogenic agents present in the original medium, including the vegetative and sporulated bacterial forms, with this deactivation being irreversible,
The preservation of a majority of the activity of the components of the original medium, particularly the lipase,
An improvement of the storage period; in particular, lipase preserves up to 60% of its activity even after a storage period of at least 3 months at a temperature that varies between −18° C. and the ambient temperature; in addition, no resumption of growth of deactivated microorganisms is observed even after a storage period of at least 6 months for a storage temperature that varies between −18° C. and the ambient temperature.

The process can therefore be used to deactivate at least one pathogenic agent that is present in the breast milk that is to be treated.

The pathogenic agents can be particularly bacterial species such as Staphylococcus aureus, Bacillus cereus, Bacillus atrophaeus, Pseudomonas aeruginosa, Escherichia coli, Streptococcus agalactiae, Listeria monocytogenes, etc.; yeasts that belong to, for example, the genus Candida; molds that belong to, for example, the genus Apergillus or Penicillium; viruses such as the Cytomegalovirus, HIV (Human Immunodeficiency Virus), the virus of hepatitis A, etc.; or any other pathogenic agent that can contaminate breast milk by endogenic or exogenic means.

In particular, the process makes possible the deactivation of bacterial spores. The bacterial spores can be, for example, the species Bacillus atrophaeus, Bacillus cereus, Bacillus stearothermophilus, Clostridium perfringens, Clostridium bifermentans, Clostridium sporogenes, or any other species that belongs to the genera Bacillus, Clostridium or Sporosarcina.

The deactivation rate of the pathogenic agents that is obtained by the implementation of the process according to the invention is preferably greater than or equal to 4 log, and the deactivation may be total.

The process can also be used for improving the preservation, in particular the storage period of the breast milk. The treated milk can actually be stored for at least 6 months, for storage temperatures of between −18° C. and the ambient temperature. The treated milk can thus be stored longer and under advantageous conditions from an economical standpoint relative to the thermal pasteurization process. It is possible to transport the treated milk easily according to the invention, and it is no longer necessary to resort to freeze-drying as is the case today for transporting the milk that is treated by thermal pasteurization that is not stored under these conditions.

The products that are obtained after treatment according to the invention can therefore be characterized by a level of deactivation of the pathogenic agents that are initially present at a concentration of at least 4 log (equivalent to 10⁴ UFC/ml).

Deactivation level according to the invention is defined as the level of deactivated bacterial agents in the treated product relative to the level of total bacterial agents initially present in breast milk. This level can be expressed by log, knowing that for x log, this corresponds to a percentage of deactivated bacterial agents of 100-10(^{2-x}).

For example:
A deactivation level of 4 log means that 99.99% of the bacterial agents that are present in the medium are deactivated,
A deactivation level of 2 log means that 99% of the bacterial agents that are present in the medium are deactivated,
A level of 5 log means that 99.999% of the bacterial agents that are present in the medium are deactivated.

According to the invention, the percentage of deactivated bacterial agents that are present in the medium after treatment is therefore greater than or equal to 99.99% of the bacterial agents that are initially present in breast milk.

Furthermore, the limit of 4 log advantageously corresponds to the limit set by numerous agencies for evaluating the possibility of implementing alternative treatments for ensuring the microbiological safety of products of biological origin. For example, the STAATT (State and Territorial Association on Alternate Treatment Technologies) set standards for the evaluation of the effectiveness of alternative processes for the destruction of infectious waste. In its definition of Level III, “such a process should demonstrate its ability to destroy infectious agents by leading to a reduction of 6 log of the vegetative forms and a reduction of 4 log of the sporulated forms.”

The products that are obtained by implementing the process according to the invention can also be characterized by:
A retention of the activity of lipase relative to the initial value before treatment that is at least equal to 50%,
A retention of the activity of lysozyme relative to the initial value before treatment that is at least equal to 90%,
A retention of the activity of lactoferrin relative to the initial value before treatment that is at least equal to 85%,
A retention of the activity of caseins (K, αₛ₁, β) relative to the initial value before treatment that is at least equal to 95%,
A retention of the activity of lactalbumin relative to the initial value that is at least equal to 90%.

Because of their advantageous characteristics, these products can be used as products to be administered to premature babies and nursing infants so as to meet their nutritional and metabolic needs.

The invention will now be illustrated by nonlimiting examples and tests.

### Experimentation Conditions

### Abbreviations

In the examples, the abbreviations that are used are the following:
VA: Speed of application of the pressure, expressed in MPa·s⁻¹
Ti: Initial temperature of the treatment, expressed in ° C.
MA: Mode of application of the pressure, either continuously (cont.) or cyclically (cycl.). The period of pressure hold will be provided (t, expressed in minutes) and in the case of a cyclic application mode, the cycle number (n) as well as the latency period at the ambient pressure (T_{lat.}, expressed in minutes) will be specified.
P: Value of the pressure, expressed in MPa.
Pf: Profile of compression or decompression
Nₐᵥ: Concentration of bacteria before “high-pressure” treatment, expressed in log
Nₐₚ: Concentration of bacteria after “high-pressure” treatment, expressed in log
ED: Destructive effectiveness of the treatment (Nₐᵥ-Nₐₚ), expressed in log

The criterion adopted for the tests for estimating that the deactivation effectiveness of a treatment was adequate was ED≧4.0 log.

General Characteristics of the Treatment Applied with the Process According to the Invention

Each high-pressure treatment is defined according to a maximum of seven parameters, namely the value of the pressure, the speed of application of the pressure and the decrease in pressure, the mode of application of the pressure, the profile of compression and decompression, the duration of treatment, the latency period between each cycle, and the temperature.
The value of the pressure (P) is equivalent to the pressure level at which the high-pressure treatment is carried out. The latter is expressed in MegaPascal (MPa) or in bar.
The speed of application of the pressure (VA) for the compression corresponds to the length of time necessary for reaching the final stage in which the high-pressure treatment is done or for reaching one or more intermediate stages; it is expressed in MPa·s⁻¹.
The speed of application of the pressure (VA) for the decompression corresponds to the length of time that is necessary for reaching the ambient pressure or an intermediate pressure (pressure of an intermediate stage or intermediate pressure applied between two cycles); it is expressed in MPa·s⁻¹.
The mode of application of the pressure (MA) represents the way in which the latter is applied, i.e., either continuously or in a cyclical manner. In continuous mode, the sample is compressed to the desired pressure, kept at this pressure for a duration of treatment t, and finally brought back to ambient pressure. In the case of cyclic application, each linking (corresponding to a cycle) of compression/pressure hold/decompression can be repeated several times. For example, for a 10-minute treatment, the latter can be carried out in continuous mode, and in this case, the pressure is maintained for 10 minutes before returning to the ambient pressure; or in cyclical mode, and in this case, the treatment can be divided into n cycles, with the pressure being maintained for 10/n minutes for each cycle (for example, 5 cycles of 2 minutes). The pressure between each cycle can be ambient pressure or an intermediate pressure between the maximum treatment pressure and the ambient pressure.
The profile of compression or decompression (Pf) for a cycle corresponds to the general form of the application of the pressure during the increase or the decrease.
The latency period (tₗₐₜ) between each cycle. This latency period is defined as the length of time between each cycle at the ambient pressure or at an intermediate pressure.
The duration of treatment (t) is defined as the length of time for which the maximum pressure is maintained for each cycle once the desired pressure is reached.
The initial temperature (T) at which the high-pressure treatment is carried out.

The overall duration of the treatment process according to the invention depends on:
Profiles of an increase and decrease Pf of pressure and speeds VA that characterize them,
The duration t at maximum constant pressure for each cycle
The duration of the latency period tₗₐₜ between each cycle.

### Description of the Equipment Used for the Tests

A piece of equipment is involved that uses a direct compression system developed in collaboration with the NFM Technologies companies FRAMATOME and the CLEXTRAL Company. Its principle rests on the thrust of a hydraulic cylinder (with surface area S₁), driven by a hydraulic pump, which then brings about the increase in the “high-pressure” chamber of internal surface area S₂ along a stationary piston. Thus, the volume of the experimental chamber decreases, which leads to an increase in internal pressure. In an approximate manner (not taking friction into account), its value is equal to the pressure delivered by the hydraulic pump multiplied by the ratio between the surfaces S₁ and S₂, namely

$$\frac{S 1}{S 2} \approx 23.$$

This equipment consists of four main parts:
A platform on which rests the reaction chamber of 3 liters of useful volume,
A low-pressure generator (hydraulic pump), producing pressure up to approximately 300 MPa,
A command-control and signal acquisition system, managed by a computer interface,
A heat generator, making it possible to cool or heat the reaction chamber between −20° C. and +80° C.

It should be noted that the process according to the invention, and particularly the process that is described in the examples, can also be applied using a piece of equipment with indirect compression where the volume of the chamber is constant, and it is the pressure-transmitting medium that is injected using one or more pump(s) in the chamber. In a general manner, the process according to the invention can be implemented by any type of high-pressure-generating equipment.

Implementation of the Treatment Applied with the Process According to the Invention

Before any treatment, it is necessary, so as to avoid any subsequent contamination, to put the product that is to be treated into an airtight and pressure-resistant packaging under working temperature conditions.

Once the sample is prepared, the latter is placed within the experimental chamber of the high-pressure equipment. The different parameters of the treatment (speed of application, pressure values, duration of treatment . . . ) are input into the computer before the start-up. Once the treatment is finished, the device is opened, and the pre-packaged samples are recovered so as to be analyzed.

For all of the tests shown below, the compression profile and the decompression profile are monotonic.

### EXAMPLES 1 AND 2

### Impact of the Process on the Vegetative Forms

### EXAMPLE 1

### Application to Rejected Milk

This first test was carried out by applying the process according to the invention to rejected milk for any treatment by the thermal pasteurization process currently used, characterized by a high level of contamination (N>10⁶ UFC/ml).

The process according to the invention was applied with the following characteristics:

VA=3.3 MPa·s⁻¹, Ti=36° C., cyclical MA with the repetition of 4 cycles (n=4), with each cycle being defined by a period of pressure hold t=10 minutes at P=330 MPa and a latency period at the ambient pressure between each cycle t_{lat.}=5 minutes.

The application of this process to rejected milk led to a total reduction of the contaminating flora initially present at a concentration that is equal to 8.1 log.

Other tests were carried out on rejected breast milk by using processes characterized by various values of parameters selected from the ranges indicated in the patent application. The results of destructive effectiveness after application of these various treatments are provided in the table below.

| | Traitement HP | | | | | | | | | | | | |
|---|---|---|---|---|---|---|---|---|---|---|---|---|---|
| | | | | Cyclage 1 | | | | Cyclage 2 | | | | | |
| N° | VA | Ti | | t | P | | t_{lat.} | t | P | | t_{lat.} | Lait rebuté | |
| trait. | (MPa · s⁻¹) | (° C.) | MA | (min) | (MPa) | n | (min) | (min) | (MPa) | n | (min) | N_{av.} | ED |
| 1 | 3,3 | 36 | cycl. | 10 | 330 | 4 | 5 | | | | | 8,1 | 8,1 |
| 2 | 3,3 | 36 | cycl. | 10 | 350 | 4 | 5 | | | | | 7,9 | 7,9 |
| 3 | 3,3 | 36 | cycl. | 15 | 300 | 3 | 5 | | | | | 7,5 | 7,5 |
| 4 | 3,3 | 28 | cycl. | | | | 20 | 5 × 2 min | 300 | 2 | 5 | 7,9 | 7,9 |

[Note:
All commas in the table above should be periods.]
[Key:]
N° trait. = Treatment No.
Traitement HP = High-Pressure Treatment
Cyclage = Cycling
Lait rebuté = Rejected Milk

### EXAMPLE 2

### Deactivation of S. Aureus

This test has as its objective to show the deactivation of Staphylococcus aureus, an important contaminant of breast milk. Currently, the treated lots of breast milk are eliminated if they have a contamination N>10⁴ UFC/ml.

The process according to the invention was applied to breast milk deliberately contaminated with a suspension of S. aureus so as to reach an initial concentration in milk that is equal to 6.6 log. The process according to the invention was applied with the following characteristics: VA=3.3 MPa·s⁻¹, Ti=36° C., cyclical MA with the repetition of 4 cycles (n=4), with each cycle being defined by a period of pressure hold t=10 minutes at P=330 MPa and a latency period at the ambient pressure between each cycle t_{lat.}=5 minutes.

The application of this process led to a total reduction of the contamination starting from a very significant initial contamination.

Other tests were carried out on breast milk deliberately contaminated with a suspension of Staphylococcus aureus by using processes characterized by various values of parameters selected from the ranges claimed in the patent application. The results of destructive effectiveness after application of these various treatments are provided in the table below.

| | Traitement HP | | | | | | | | |
|---|---|---|---|---|---|---|---|---|---|
| | | | | Cyclage | | | | Lait + | |
| N° | VA | Ti | | t | P | | t_{lat.} | S. aureus | |
| trait. | (MPa · s⁻¹) | (° C.) | MA | (min) | (MPa) | n | (min) | N_{av.} | ED |
| 1 | 3,3 | 36 | cycl. | 10 | 330 | 4 | 5 | 6,6 | 6,6 |
| 2 | 3,3 | 36 | cycl. | 10 | 350 | 4 | 5 | 6,7 | 6,7 |
| 3 | 3,3 | 36 | cycl. | 15 | 300 | 3 | 5 | 7,1 | 7,1 |
| 5 | 1 | 36 | cycl. | 10 | 350 | 4 | 5 | 6,7 | 6,7 |

[Note:
All commas in the table above should be periods.]
Key:
N° trait. = Treatment No.
Traitement HP = High-Pressure Treatment
Cyclage = Cycling
Lait = Milk

### EXAMPLES 3 TO 5

### Impact of the Process on the Sporulated Forms

### EXAMPLE 3

### Deactivation of B. Atrophaeus

This test has as its objective to show the deactivation of spores of Bacillus atrophaeus. The process according to the invention was applied to breast milk deliberately contaminated with a suspension of spores of B. atrophaeus so as to reach an initial concentration in the milk that is equal to 5.0 log. The process according to the invention was applied with the following characteristics: VA=3.3 MPa·s⁻¹, Ti=36° C., cyclical MA with the repetition of 4 cycles (n=4), with each cycle being defined by a period of pressure hold t=10 minutes at P=330 MPa and a latency period at the ambient pressure between each cycle t_{lat.}=5 minutes.

The application of this process led to a total deactivation of the initially present spores. This deactivation is totally irreversible since after a storage period of 6 months either at −18° C. or at +4° C., or at the ambient temperature, no resumption of growth was observed.

Other tests were carried out on breast milk deliberately contaminated with a suspension of spores of B. atrophaeus by using processes characterized by various values of parameters selected from the ranges claimed in the patent application. The results of destructive effectiveness after application of these various treatments are provided in the table below.

| | Traitement HP | | | | | | | | |
|---|---|---|---|---|---|---|---|---|---|
| | | | | Cyclage | | | | Lait + B. | |
| N° | VA | Ti | | t | P | | t_{lat.} | atrophaeus | |
| trait. | (MPa · s⁻¹) | (° C.) | MA | (min) | (MPa) | n | (min) | N_{av.} | ED |
| 1 | 3,3 | 36 | cycl. | 10 | 330 | 4 | 5 | 4,9 | 4,9 |
| 2 | 3,3 | 36 | cycl. | 10 | 350 | 4 | 5 | 5,2 | 5,2 |
| 3 | 3,3 | 36 | cycl. | 15 | 300 | 3 | 5 | 4,9 | 4,9 |
| 5 | 1 | 36 | cycl. | 10 | 350 | 4 | 5 | 5,8 | 5,8 |
| 6 | 1 | 36 | cycl. | 5 | 300 | 4 | 5 | 5,1 | 5,1 |
| 7 | 1 | 36 | cycl. | 10 | 300 | 4 | 5 | 5,1 | 5,1 |
| 8 | 0,6 | 36 | cycl. | 10 | 300 | 3 | 5 | 5,0 | 5,0 |

[Note:
All commas in the table above should be periods.]
[Key:]
N° trait. = Treatment No.
Traitement HP = High-Pressure Treatment
Cyclage = Cycling
Lait = Milk

### EXAMPLE 4

### Deactivation of B. Cereus

This test has as its objective to show the deactivation of spores of Bacillus cereus. The process according to the invention was applied to breast milk deliberately contaminated with a suspension of spores of B. cereus so as to reach an initial concentration in the milk that is equal to 6.3 log. The process according to the invention was applied with the following characteristics: VA=1 MPa·s⁻¹, Ti=36° C., cyclical MA with the repetition of 4 cycles (n=4), with each cycle being defined by a period of pressure hold t=5 minutes at P=300 MPa and a latency period at the ambient pressure between each cycle t_{lat.}=5 minutes.

The application of this process led to a total deactivation of the initially present spores of B. cereus. This deactivation is totally irreversible since after a storage period of 3 months either at −18° C. or at +4° C., or at the ambient temperature, no resumption of growth was observed.

Other tests were carried out on breast milk deliberately contaminated with a suspension of spores of B. cereus by using processes characterized by various values of parameters selected from the ranges claimed in the patent application. The results of destructive effectiveness after application of these various treatments are provided in the table below.

| | Traitement HP | | | | | | | | |
|---|---|---|---|---|---|---|---|---|---|
| | | | | Cyclage | | | | Lait + B. | |
| N° | VA | Ti | | t | P | | t_{lat.} | cereus | |
| trait. | (MPa · s⁻¹) | (° C.) | MA | (min) | (MPa) | n | (min) | N_{av.} | ED |
| 1 | 3,3 | 36 | cycl. | 10 | 330 | 4 | 5 | 5,6 | 5,6 |
| 5 | 1 | 36 | cycl. | 10 | 350 | 4 | 5 | 5,2 | 5,2 |
| 6 | 1 | 36 | cycl. | 5 | 300 | 4 | 5 | 6,3 | 6,3 |
| 7 | 1 | 36 | cycl. | 10 | 300 | 4 | 5 | 5,3 | 5,3 |
| 8 | 0,6 | 36 | cycl. | 10 | 300 | 3 | 5 | 5,0 | 5,0 |

[Note:
All commas in the table above should be periods.]
[Key:]
N° trait. = Treatment No.
Traitement HP = High-Pressure Treatment
Cyclage = Cycling
Lait = Milk

### EXAMPLE 5

### Deactivation of Several Pathogenic Agents

This test has as its objective to show the effectiveness of the treatment on a milk contaminated with spores of Bacillus atrophaeus N=10^{4.9} UFC/ml, with spores of Bacillus cereus N=10^{5.6} UFC/ml, and with Staphylococcus aureus N=10^{6.6} UFC/ml. The process according to the invention was applied to the milk, with the following characteristics: VA=3.3 MPa·s⁻¹, Ti=36° C., cyclical MA with the repetition of 4 cycles (n=4), with each cycle being defined by a period of pressure hold t=10 minutes at P=330 MPa, and a latency period at the ambient pressure between each cycle t_{lat.}=5 minutes.

For all of these contaminating agents of very different natures, a total and irreversible deactivation is observed. This result shows a very high level of effectiveness of the process with respect to microbiological safety.

### EXAMPLE 6

### Impact of the Process on Other Pathogenic Agents

This test has as its objective to show the effectiveness of the process according to the invention in the case of viral contamination.

The tests were carried out on a suspension of Cytomegalovirus containing an initial concentration of infecting viral particles of greater than 7 log.

The process according to the invention was applied to the milk, with the following characteristics: VA=1 MPa·s⁻¹, Ti=36° C., cyclical MA with the repetition of 4 cycles (n=4), with each cycle being defined by a period of pressure hold t=5 minutes at P=300 MPa, and a latency period at the ambient pressure between each cycle t_{lat.}=5 minutes.

The infectivity tests demonstrated a total deactivation of the virus.

### EXAMPLES 7 TO 9

### Retention of the Properties of the Components

These tests have as their objective to evaluate the impact of the process according to the invention on the essential components of the milk.

### EXAMPLE 7

### Lipase

Lipase is a thermally fragile component whose activity is totally reduced after treatment by the thermal pasteurization process. The process according to the invention was applied to the milk, with the following characteristics: VA=1 MPa·s⁻¹, Ti=36° C., cyclical MA with the repetition of 4 cycles (n=4), with each cycle being defined by a period of pressure hold t=5 minutes at P=300 MPa and a latency period at the ambient pressure between each cycle t_{lat.}=5 minutes.

The results that are obtained after metering of the lipase show a retention of the activity of the lipase of approximately 68% relative to the values of untreated breast milk, contrary to existing processes that make the lipase inactive.

Other tests have been carried out on breast milk by using processes characterized by various values of parameters selected from the ranges claimed in the patent application. The results in terms of percentage of residual activity of lipase after application of these various treatments are provided in the table below.

| | Traitement HP | | | | | | | |
|---|---|---|---|---|---|---|---|---|
| | | | | Cyclage | | | | |
| N° | VA | Ti | | t | P | | t_{lat.} | % act. |
| trait. | (MPa · s⁻¹) | (° C.) | MA | (min) | (MPa) | n | (min) | lipase |
| 1 | 3,3 | 36 | cycl. | 10 | 330 | 4 | 5 | 56% |
| 3 | 3,3 | 36 | cycl. | 15 | 300 | 3 | 5 | 87% |
| 5 | 1 | 36 | cycl. | 10 | 350 | 4 | 5 | 95% |
| 6 | 1 | 36 | cycl. | 5 | 300 | 4 | 5 | 68% |
| 7 | 1 | 36 | cycl. | 10 | 300 | 4 | 5 | 95% |

[Note:
All commas in the table above should be periods.]
[Key:]
N° trait. = Treatment No.
Traitement HP = High-Pressure Treatment
Cyclage = Cycling
% act. lipase = % of Lipase Activity

### EXAMPLE 8

### Lysozyme and Lactoferrin

Lysozyme (Lyso) and lactoferrin (LF) are components characterized by antibacterial functions.

The process according to the invention with different parameters was applied to breast milk with the characteristics specified in the table below:

| | Traitement HP | | | | | | | | |
|---|---|---|---|---|---|---|---|---|---|
| | | | | Cyclage | | | | % conc. | |
| N° | VA | Ti | | t | P | | t_{lat.} | résiduelle | |
| trait. | (MPa · s⁻¹) | (° C.) | MA | (min) | (MPa) | n | (min) | Lyso | LF |
| 9 | 3,3 | 28 | cycl. | 10 | 300 | 2 | 0,5 | 95% | 93% |
| 10 | 3,3 | 28 | cycl. | 2 | 300 | 5 | 0,5 | 95% | 97% |
| 11 | 3,3 | 28 | cycl. | 5 × 2 min | 300 | 2 | 5 | 100% | 94% |

[Note:
All commas in the table above should be periods.]
[Key:]
N° trait. = Treatment No.
Traitement HP = High-Pressure Treatment
Cyclage = Cycling
% conc. résiduelle = % of Residual Concentration

The results that are obtained after metering of these two components show a retention of activity for lysozyme that is at least equal to 95% and for lactoferrin that is at least equal to 93%

### EXAMPLE 9

### Caseins and Lactalbumin

The caseins (K, α_{S1}, β) and lactalbumin (α-lac) are involved in the nutritional functions of breast milk.

The process according to the invention with different parameters was applied to breast milk with the characteristics specified in the table below:

| | Traitement HP | | | | | | | | | | |
|---|---|---|---|---|---|---|---|---|---|---|---|
| | | | | Cyclage | | | | % conc. | | | |
| N° | VA | Ti | | t | P | | t_{lat.} | résiduelle | | | |
| trait. | (MPa · s⁻¹) | (° C.) | MA | (min) | (MPa) | n | (min) | cas κ | cas αₛ₁ | cas β | α-lac |
| 9 | 3,3 | 28 | cycl. | 10 | 300 | 2 | 0,5 | 100% | 90% | 94% | 97% |
| 10 | 3,3 | 28 | cycl. | 2 | 300 | 5 | 0,5 | 100% | 93% | 100% | 99% |
| 11 | 3,3 | 28 | cycl. | 5 × 2 min | 300 | 2 | 5 | 100% | 78% | 100% | 96% |

[Note:
All commas in the table above should be periods.]
[Key:]
N° trait. = Treatment No.
Traitement HP = High-Pressure Treatment
Cyclage = Cycling
% conc. résiduelle = % of Residual Concentration

The results that are obtained after metering these two components show that the process according to the invention makes it possible to preserve a large portion of caseins (at least 78%) and a safeguard of the concentration of lactalbumin of approximately 96 to 99%.

### EXAMPLES 10

### Irreversibility of the Microbiological Deactivation and Preservation of Treated Milk

Samples of pasteurized milk were deliberately contaminated either by spores of Bacillus atrophaeus or by spores of Bacillus cereus. Similar tests were carried out on samples of rejected milk.

At the end of the high-pressure treatment, these samples were stored protected from light either at the ambient temperature, or at +4° C. or at −18° C., and counts were taken after various storage periods (D+7, D+14, D+30, D+3 months, and D+6 months).

Note: These counts were taken by inoculating a volume of 1 ml of a pure or dilute sample by using the method by incorporation of gelose TSA.

Samples of rejected milk and pasteurized milk contaminated with spores of Bacillus atrophaeus were subjected to high-pressure treatment with the following characteristics: VA=3.3 MPa·s⁻¹, Ti=36° C., cyclical MA with the repetition of 4 cycles (n=4), with each cycle being defined by a period of pressure hold t=10 minutes at P=330 MPa and a latency period at the ambient pressure between each cycle t_{lat.}=5 minutes.

Samples of pasteurized milk contaminated with spores of Bacillus cereus were subjected to high-pressure treatment with the following characteristics: VA=1 MPa·s⁻¹, Ti=36° C., cyclical MA with the repetition of 4 cycles (n=4), with each cycle being defined by a period of pressure hold t=5 minutes at P=300 MPa and a latency period at the ambient pressure between each cycle t_{lat.}=5 minutes.

In parallel with samples treated under high pressure, untreated control samples were subjected to the same storage conditions.

The results, expressed in log of bacterial concentration, are presented in the table below:

| | | | J + 30 | | | J + 3 mois | | | J + 6 mois | | |
|---|---|---|---|---|---|---|---|---|---|---|---|
| | | J0 | Tamb. | 4° C. | −18° C. | Tamb. | 4° C. | −18° C. | Tamb. | 4° C. | −18° C. |
| B. atrophaeus | non | 4,9 | 3,9 | 4,8 | 4,9 | 2,3 | 4,7 | 4,7 | 5,9 | 4,3 | 4,9 |
| (spores) | traité | | | | | | | | | | |
| | HP | 0 | 0 | | 0 | 0 | 0 | 0 | 0 | 0 | 0 |
| B. cereus | non | 6,3 | | 4,7 | 5,0 | 6,9 | 4,5 | 4.9 | | | |
| (spores) | traité | | | | | | | | | | |
| | HP | 0 | | 0 | 0 | 0 | 0 | 0 | | | |
| Lait rebuté | non | 8,1 | 8,5 | 8,4 | 8,0 | | 7,7 | 7,7 | | 2,0 | 6,4 |
| | traité | | | | | | | | | | |
| | HP | 0 | 0 | 0 | 0 | | 0 | 0 | | 0 | 0 |

“O” means that no colony was able to develop, even after having placed 1 ml of sample under optimal cultivation conditions for the resumption of bacterial growth.
[Note:
All commas in the table above should be periods.]
[Key:]
JO = D0
J + 30 = D + 30
J + 3 mois = D + 3 months
J + 6 mois = D + 6 months
Tamb. = T ambient
non traité = Untreated
Lait rebuté = Rejected Milk

It is noted that regardless of the type of sample, when treatment is not done under high pressure, it is possible to detect contaminating microorganisms regardless of the temperature or the storage period.

In the case of samples subjected to the processes of the invention, no resumption of growth could be demonstrated regardless of the temperature and the storage period (even after a period of 3 months for the samples of milk contaminated with spores of B. cereus or a period of 6 months for the samples of rejected milk or milk contaminated with spores of B. atrophaeus).

Samples of raw milk were subjected to high-pressure treatment with the following characteristics: VA=1 MPa·s⁻¹, Ti=36° C., cyclical MA with the repetition of 4 cycles (n=4), with each cycle being defined by a period of pressure hold t=5 minutes at P=300 MPa and a latency period at the ambient pressure between each cycle t_{lat.}=5 minutes.

After high-pressure treatment, the samples were stored either at the ambient temperature or at +4° C. or at −18° C. for 1 month or 3 months. At the end of each period, the corresponding samples were put at −18° C. waiting for dosages of lipase. A sample D0 was also put directly at −18° C. so as to serve as a control.

The percentages of residual activity for lipase are provided in the table below:

| | T_{storage} | | |
|---|---|---|---|
| Storage period | −18° C. | 4° C. | T_{ambient} |
| 1 month | 68% | 62% | 63% |
| 3 month | | 56% | 60% |

1. Process for the treatment of breast milk, characterized in that it comprises at least two cycles, with each cycle consisting in applying to the medium a maximum pressure of between 200 and 400 MPa with a compression speed of between 0.5 and 8 MPa·s⁻¹ and a decompression speed of between 0.5 and 100 MPa·s⁻¹, with the initial temperature of the medium being between 25° C. and 50° C.

2. Process for treatment of breast milk according to claim 1, wherein each cycle has an application period of the maximum pressure of between 2 and 60 minutes.

3. Process for treatment of breast milk according to claim 1, wherein each cycle has an application period of the maximum pressure of the cycle of between 2 and 10 minutes.

4. Process for treatment of breast milk according to claim 1, wherein at least two of the cycles have a different application period of the maximum pressure.

5. Process for treatment of breast milk according to claim 1, wherein the pressure between two cycles is the ambient pressure or an intermediate pressure between the ambient pressure and the maximum pressure(s) of treatment applied during said two cycles.

6. Process for treatment of breast milk according to claim 1, wherein at least two of the application cycles have a different compression speed and/or decompression speed.

7. Process for treatment of breast milk according to claim 1, wherein the compression speed and/or the decompression speed varies/vary until the desired pressure is reached.

8. Process for treatment of breast milk according to claim 1, wherein at least two cycles have a different compression profile and/or a different decompression profile.

9. Process for treatment of breast milk according to claim 1, wherein for the same cycle, the compression profile and the decompression profile are different.

10. Process for treatment of breast milk according to claim 1, wherein between each cycle, there is a latency period.

11. Process for treatment of breast milk according to claim 10, wherein the latency period between each cycle is between 10 seconds and 5 minutes.

12. Process for treatment of breast milk according to claim 1, wherein the applied pressure is between 270 and 330 MPa.

13. Process for treatment of breast milk according to claim 1, wherein the compression speed and/or the decompression speed is between 0.5 and 2 MPa·s⁻¹.

14. Process for treatment of breast milk according to claim 1, wherein the initial temperature is between 30 and 40° C.

15. Process for treatment of breast milk according to claim 1, wherein the breast milk is treated in a container that is completely or partially deformable.

16. A process for deactivating at least one pathogenic agent that is present in breast milk, comprising subjecting breast milk to at least two cycles of pressure and compression, with each cycle consisting in applying to the medium a maximum pressure of between 200 and 400 MPa with a compression speed of between 0.5 and 8 MPa·s⁻¹ and a decompression speed of between 0.5 and 100 MPa·s⁻¹, with the initial temperature of the medium being between 25° C. and 50° C., wherein at least one pathogenic agent is said breast milk is deactivated by said two cycles of pressure and compression.

17. The process according to claim 16, wherein at least one bacterial form in the vegetative or sporulated state present in breast milk is deactivated.

18. The process according to claim 16, wherein after subjecting the breast milk to said at least two cycles of pressure and compression, the breast milk has a storage period for at least 6 months at a temperature of between −18° C. and 25° C.

19. Product that is obtained by the implementation of the process according to claim 1, wherein it has a level of deactivation of the bacterial spores present in the medium that is at least equal to 4 log.

20. Product according to claim 19, wherein the product meets the nutritional and metabolic needs of premature babies and nursing infants.
